(19) United States
(12) Patent Application Publication
(10) Pub. No.: US 2013/0020020 A1
(43) Pub. Date: Jan. 24, 2013

(54) Adhering Jig and Adhering Method for Screen Protector Plastic Sheet

(71) Applicant: Chun-Lin Liu, Tainan City (TW)

(72) Inventor: Chun-Lin Liu, Tainan City (TW)

(21) Appl. No.: 13/186,585

(22) Filed: Jul. 20, 2011

(51) Int. Cl. B32B 38/10; B32B 37/12

(52) U.S. Cl. 156/247; 156/556

(57) ABSTRACT

An adhering jig and an adhering method for screen protector plastic sheets are provided for encapsulating and packing, by means of the adhering jig capable of safe coverage, screen protector plastic sheets intended to protect the surfaces of panel cell phones against scratches inflicted by foreign bodies, in the course of delivery or sales after being manufactured by a manufacturer, so as to preclude contact with and prevent dents, bends, or damage from occurring to the screen protector plastic sheets and covering the surfaces of the panel cell phones with the screen protector plastic sheets by means of the packing-oriented adhering jig to achieve precise smoothness and flawless attachment.

### BACKGROUND OF THE INVENTION

1. Field of the Invention

The present invention relates to adhering jigs and adhering methods for screen protector plastic sheets, and more particularly, to an adhering jig and an adhering method suitable for screen protector plastic sheets and effective in encapsulating and packing, by means of an adhering jig capable of safe coverage, screen protector plastic sheets intended to protect the surfaces of panel cell phones against scratches inflicted by foreign bodies, in the course of delivery or sales after being manufactured by a manufacturer, so as to preclude contact with and prevent dents, bends, or damage from occurring to the screen protect or plastic sheets and effective in covering the surfaces of the panel cell phones with the screen protector plastic sheets by means of the packing-oriented adhering jig to achieve precise smoothness and flawless attachment.

2. Description of the Prior Art

After being manufactured by a manufacturer, conventional screen protector plastic sheets for use with panel cell phones are usually directly packed and supplied to retailers on the market for a customer to purchase according to the specifications of the customer's cell phone, as far as the size of the purchased screen protector plastic sheet is concerned. However, screen protector plastic sheets directly packed in the aforesaid manner are likely to be dented or damaged in the course of delivery out of human beings' carelessness, thereby resulting in non-conforming products whose surfaces are left with traces of dents and bends.

To make sure that screen protector plastic sheets intended to protect the surfaces of their panel cell phones against scratches inflicted by foreign bodies can be smoothly adhered to their panel cell phones, customers usually ask a retailer (from which the customers have just bought the panel cell phones) to help them adhere the screen protector plastic sheets to the surfaces of their newly-purchased panel cell phones or take their newly-purchased panel cell phones to a shop where paid adhering service is offered.

### BRIEF SUMMARY OF THE INVENTION

The present invention aims to solve problems facing the conventional packing process and the conventional adhering process of screen protector plastic sheets for protecting the surfaces of panel cell phones with a view to encapsulating and packing, by means of an adhering jig capable of safe coverage, screen protector plastic sheets in the course of delivery or sales after being manufactured by a manufacturer, so as to preclude contact with and prevent dents, bends, or damage from occurring to the screen protector plastic sheets and effective in covering the surfaces of the panel cell phones with the screen protector plastic sheets by means of the packing-oriented adhering jig to achieve precise smoothness and flawless attachment.

A primary objective of the present invention is to provide an adhering jig adapted for use with screen protector plastic sheets for packing a panel cell phone. The adhering jig comprises an upper layer element, a middle layer element, and a bottom layer element. The upper layer element and the middle layer element are separately formed. An inner portion of the middle layer element is cut away from the middle layer element according to the pre-packing shape of the panel cell phone such that a receiving space corresponding in periphery thereto is inwardly formed in the middle layer element; meanwhile, the inner portion thus cut away from the middle layer element starts to function as the bottom layer element. An inner portion of the upper layer element is cut away from the upper layer element according to the pre-packing shape of the screen protector plastic sheet such that a space corresponding in position thereto is inwardly formed in the upper layer element. Matching holes are penetratingly formed in the upper layer element and the middle layer element, respectively. Afterward, the upper layer element and the middle layer element are laminated with each other. To pack the screen protector plastic sheet by means of the adhering jig, it is feasible to have the bottom layer element received in the receiving space of the middle layer element and have the screen protector plastic sheet fitted inside the space of the upper layer element. Afterward, the adhering jig and the screen protector plastic sheets are completely packed with a covering film for effectively preventing the screen protector plastic sheets from being dented or damaged due to an inadvertent collision that happens in the course of delivery or sales.

The second objective of the present invention is to have recesses formed at the periphery of the receiving space of the middle layer element for receiving at least one key of the panel cell phone, and have an upward-tapering spacing formed between the receiving space of the middle layer element and the space of the upper layer element for subjecting the panel cell phone to directional restriction imposed by the periphery of the space of the upper layer element after the panel cell phone is inserted into the middle layer element.

The third objective of the present invention is for the upper layer element, the middle layer element, and the bottom layer element of the adhering jig to be made of foam, EVA, etc. for the purpose of implementing the present invention.

Another primary objective of the present invention is to cover the panel cell phone with a screen protector plastic sheet by taking the steps of: removing the bottom layer element from the adhering jig comprising the upper layer element, the middle layer element, and the bottom layer element; inserting the pre-adhering surface of the panel cell phone into the receiving space of the middle layer element from below; peeling the anti-scratch membrane from the screen protector plastic sheet; inserting the adhesive side of the screen protector plastic sheet into the space of the upper layer element; adhering the adhesive side of the screen protector plastic sheet to the pre-adhering surface of the panel cell phone; and removing the panel cell phone from the receiving space of the middle layer element from below, thereby allowing the screen protector plastic sheet to be coupled to the surface of the panel cell phone and achieve precise smoothness and flawless attachment.

### BRIEF DESCRIPTION OF THE SEVERAL VIEWS OF THE DRAWINGS

FIG. 1 is an exploded view of an adhering jig for screen protector plastic sheets according to the present invention;

FIG. 2 is a perspective view of the adhering jig for screen protector plastic sheets according to the present invention;

FIG. 3 is a schematic cross-sectional view of the adhering jig for screen protector plastic sheets according to the present invention;

FIG. 4 is a schematic view of the adhering jig and a screen protector plastic sheet before a packing process according to the present invention;

FIG. 5 is a schematic view of the adhering jig and the screen protector plastic sheet after the packing process according to the present invention;

FIG. 6 is a schematic view of the adhering jig and the screen protector plastic sheet before an adhering process according to the present invention;

FIG. 7 is a schematic cross-sectional view of the adhering jig and the screen protector plastic sheet adhered thereto according to the present invention; and

FIG. 8 is a schematic view of the screen protector plastic sheet completely adhered to a panel cell phone according to the present invention.

### DETAILED DESCRIPTION OF THE EMBODIMENTS OF THE INVENTION

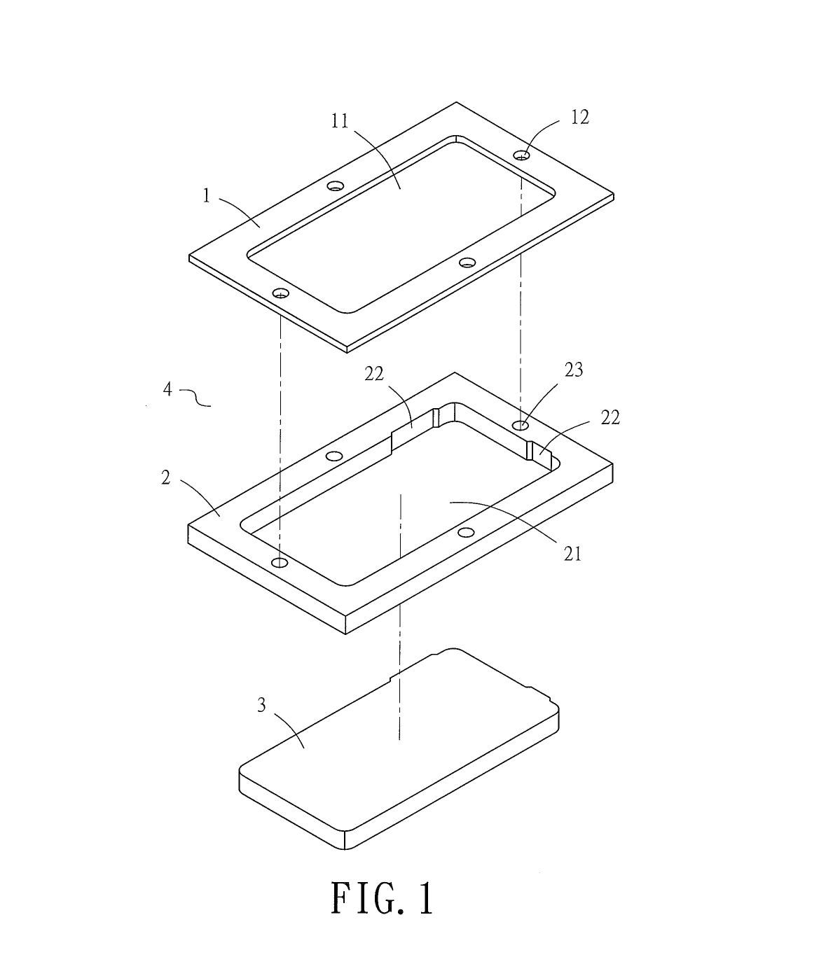

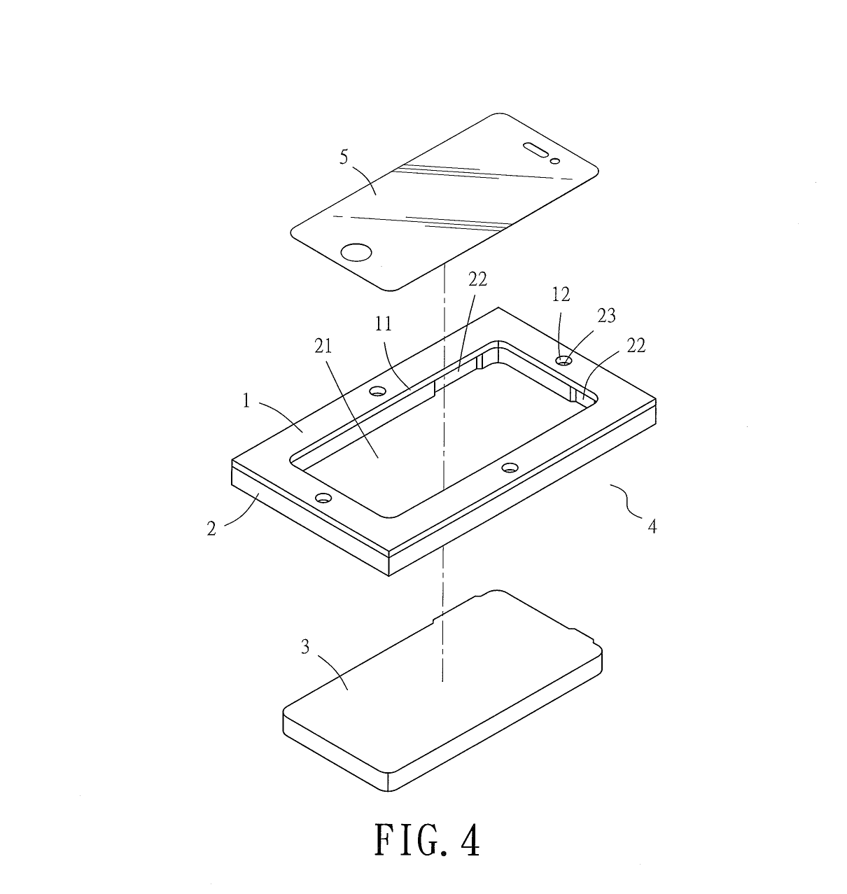

Referring to FIG. 1, the present invention relates to an adhering jig and an adhering method for screen protector plastic sheets, and the present invention discloses a packing-oriented adhering jig 4 adapted for use with a screen protector plastic sheet 5 (see FIGS. 4-8) for packing a panel cell phone (not shown). The adhering jig 4 comprises an upper layer element 1, a middle layer element 2, and a bottom layer element 3.

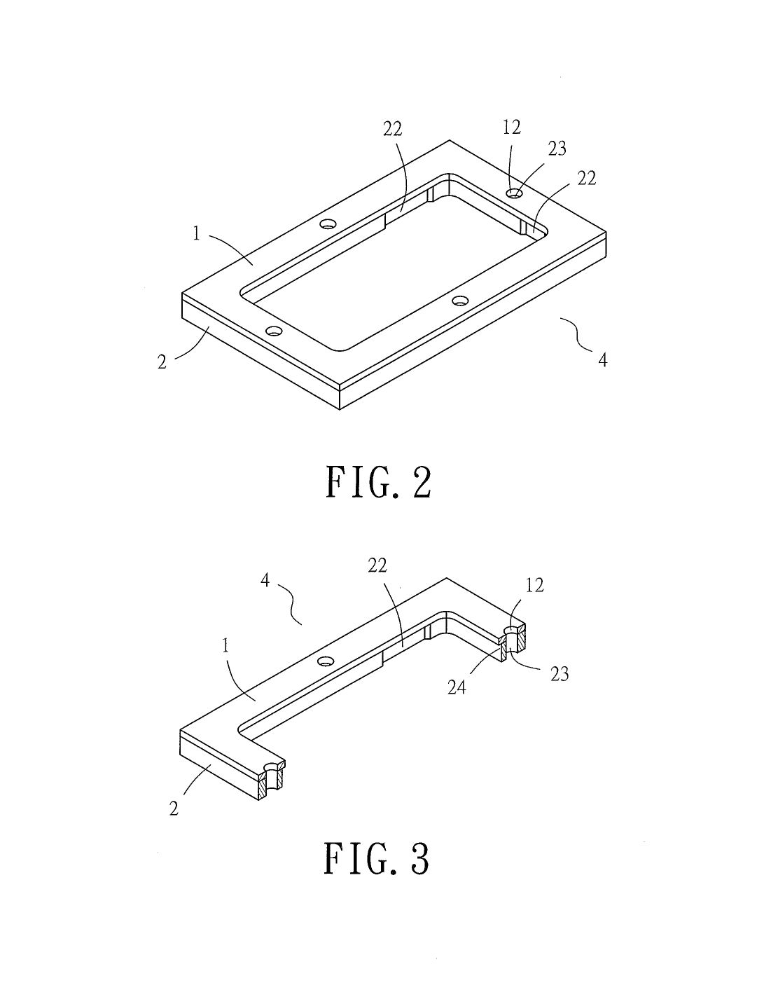

The upper layer element 1 and the middle layer element 2 are separately formed. An inner portion of the middle layer element 2 is cut away from the middle layer element 2 according to the pre-packing shape of the panel cell phone such that a receiving space 21 corresponding in periphery thereto is inwardly formed in the middle layer element 2. Recesses 22 are formed at the periphery of the receiving space 21 for receiving at least one key of the panel cell phone. As described above, the inner portion of the middle layer element 2 is cut away from the middle layer element 2; meanwhile, the inner portion thus cut away from the middle layer element 2 starts to function as the bottom layer element 3. The upper layer element 1, the middle layer element 2, and the bottom layer element 3 are made of foam, EVA, etc. for the purpose of implementing the present invention. An inner portion of the upper layer element 1 is cut away from the upper layer element 1 according to the pre-packing shape of the screen protector plastic sheet 5 such that a space 11 corresponding in position thereto is inwardly formed in the upper layer element 1. Matching holes 12, 23 are penetratingly formed in the upper layer element 1 and the middle layer element 2, respectively. Afterward, the upper layer element 1 and the middle layer element 2 are aligned with each other in accordance with the holes 12, 23 peripherally disposed therein, respectively, and then laminated with each other to integrally form a unitary structure (as shown in FIG. 2). A spacing 24 (shown in FIG. 3) which tapers upward is formed between the receiving space 21 of the middle layer element 2 and the space 11 of the upper layer element 1 for subjecting the panel cell phone to directional restriction imposed by the periphery of the space 11 of the upper layer element 1 after the panel cell phone is inserted into the middle layer element 2.

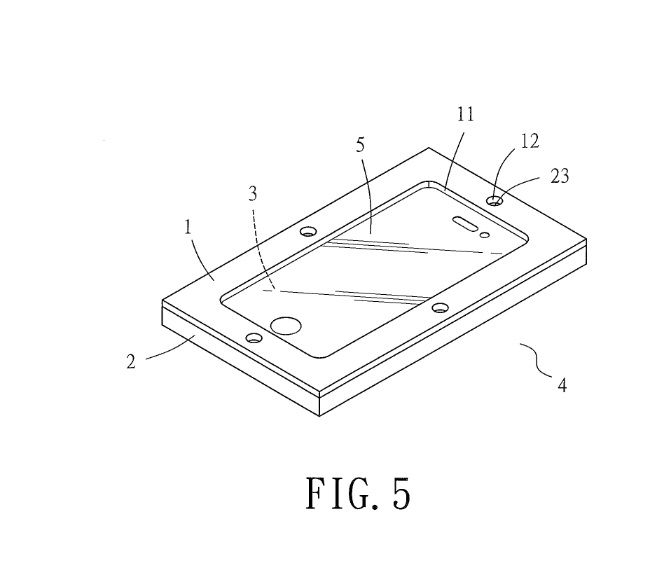

To pack the screen protector plastic sheet 5 by means of the adhering jig 4 (as shown in FIG. 4), it is feasible to have the bottom layer element 3 received in the receiving space 21 of the middle layer element 2 and have the screen protector plastic sheet 5 fitted inside the space 11 of the upper layer element 1 (as shown in FIG. 5). Afterward, the adhering jig 4 and the screen protector plastic sheet 5 are completely packed with a covering film for effectively preventing the screen protector plastic sheet 5 from being dented or damaged due to an inadvertent collision that happens in the course of delivery or sales.

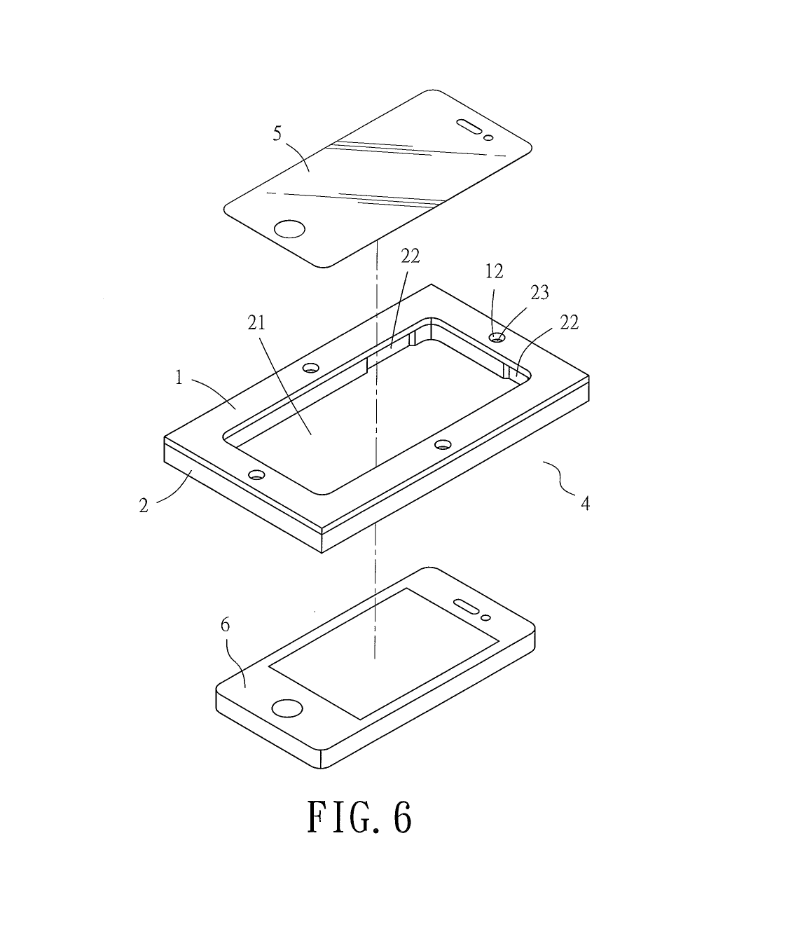

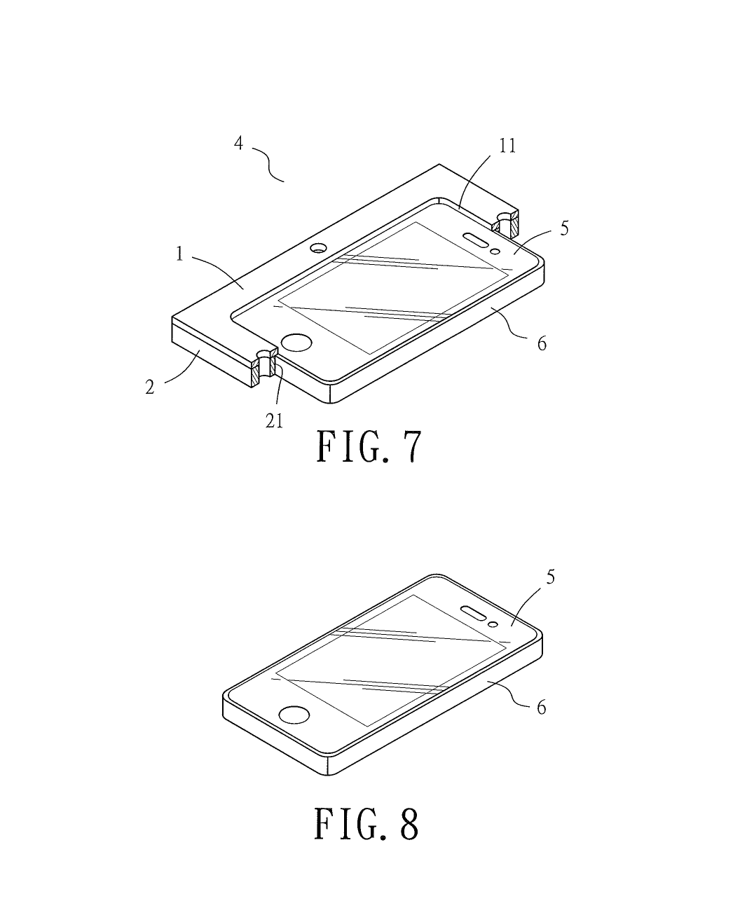

Furthermore, to enable the packing-oriented adhering jig 4 to assist the screen protector plastic sheet 5 in covering a panel cell phone 6 (as shown in FIG. 6), it is feasible to remove the bottom layer element 3 from the adhering jig 4 comprising the upper layer element 1, the middle layer element 2, and the bottom layer element 3 (as shown in FIG. 5), insert the pre-adhering surface of the panel cell phone 6 into the receiving space 21 of the middle layer element 2 from below (as shown in FIG. 7), peel the anti-scratch membrane from the screen protector plastic sheet 5, insert the adhesive side of the screen protector plastic sheet 5 into the space 11 of the upper layer element 1, adhere the adhesive side of the screen protector plastic sheet 5 to the pre-adhering surface of the panel cell phone 6, and remove the panel cell phone 6 from the receiving space 21 of the middle layer element 2 from below, thereby allowing the screen protector plastic sheet 5 to be coupled to the surface of the panel cell phone 6 and achieve precise smoothness and flawless attachment (as shown in FIG. 8).

What is claimed is:

1. An adhering jig for screen protector plastic sheets, the adhering jig being adapted for a screen protector plastic sheet for packing a panel cell phone, the adhering jig comprising an upper layer element, a middle layer element, and a bottom layer element, the adhering jig being characterized in that:
the upper layer element and the middle layer element are separately formed, wherein an inner portion of the middle layer element is cut away from the middle layer element according to a pre-packing shape of the panel cell phone such that a receiving space corresponding in periphery thereto is inwardly formed in the middle layer element, wherein the inner portion thus cut away from the middle layer element functions as the bottom layer element, wherein an inner portion of the upper layer element is cut away from the upper layer element according to a pre-packing shape of the screen protector plastic sheet such that a space corresponding in position thereto is inwardly formed in the upper layer element, wherein matching holes are penetratingly formed in the upper layer element and the middle layer element, respectively, and then the upper layer element and the middle layer element are laminated with each other;
to pack the screen protector plastic sheet by means of the adhering jig, it is feasible to have the bottom layer element received in the receiving space of the middle layer element and have the screen protector plastic sheet fitted inside the space of the upper layer element, and then the adhering jig and the screen protector plastic sheet are completely packed with a covering film for effectively preventing the screen protector plastic sheet from being dented or damaged due to an inadvertent collision that happens during delivery or sales;

2. The adhering jig of claim 1, wherein recesses are formed at a periphery of the receiving space of the middle layer element of the adhering jig for receiving at least one key of the panel cell phone, and an upward-tapering spacing is formed between the receiving space of the middle layer element and the space of the upper layer element for subjecting the panel cell phone to directional restriction imposed by a periphery of the space of the upper layer element after the panel cell phone is inserted into the middle layer element.

3. The adhering jig of claim 1, wherein the upper layer element, the middle layer element, and the bottom layer element of the adhering jig are made of one of foam and EVA.

4. A method for covering a panel cell phone with a screen protector plastic sheet, the method comprising the steps of:
removing a bottom layer element from an adhering jig comprising an upper layer element, a middle layer element, and the bottom layer element;
inserting a pre-adhering surface of the panel cell phone into a receiving space of the middle layer element from below;
peeling an anti-scratch membrane from the screen protector plastic sheet;
inserting an adhesive side of the screen protector plastic sheet into a space of the upper layer element;
adhering the adhesive side of the screen protector plastic sheet to the pre-adhering surface of the panel cell phone; and
removing the panel cell phone from the receiving space of the middle layer element from below, thereby allowing the screen protector plastic sheet to be coupled to the surface of the panel cell phone and achieve precise smoothness and flawless attachment.
